(19) United States
(12) Patent Application Publication
(10) Pub. No.: US 2006/0028588 A1
(43) Pub. Date: Feb. 9, 2006

(54) Auto search device and a method thereof

(75) Inventors: Jong-jin Yi, Seoul (KR); Jin-youl Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/104,498

(22) Filed: Apr. 13, 2005

(30) Foreign Application Priority Data
Aug. 9, 2004 (KR) 2004-62285

(51) Int. Cl. H04N 5/50

(52) U.S. Cl. 348/732

(57) ABSTRACT

An auto search device for a wireless TV and a method thereof. The auto search device includes: a receiver for receiving a control message with respect to information on a channel; a text message generator capable of displaying a message; a memory for storing information on a searched channel; and a controller for controlling such that an extent of channel search completion is displayed in a text message by driving the text message generator or stored in the memory according to a result of reading the control message from the receiver. Accordingly, since the control message is processed rapidly and effectively, the time required for the auto channel operation can be reduced, and the data loss which occurs due to a wireless characteristic can be compensated.

### CROSS-REFERENCE TO RELATED APPLICATIONS

This application claims priority from Korean Patent Application No. 2004-62285, filed on Aug. 9, 2004 in the Korean Intellectual Property Office, the disclosure of which is incorporated herein by reference in its entirety.

### BACKGROUND OF THE INVENTION

1. Field of the Invention

The present invention relates to an auto search device and a method thereof, and particularly, to a device capable of performing an auto search operation safely and effectively in a wireless television (TV) that receives an audio/video (AV) stream in a wireless fashion and displays it, and a method thereof.

2. Description of the Related Art

An auto search function of a general TV is to search a frequency channel having an effective TV signal by searching from a low frequency to a high frequency, assign a program number to the searched channel and store the channel. After the auto search operation is completed, a channel can be tuned according to the pre-set program number. During the auto search operation, the program numbers are usually started from the number 1 in an incrementing manner. When the auto search operation is stopped, information on channels that have been searched up to the present are stored and displayed. In case of a Phase Alternation by Line (PAL) TV, an auto sort function is performed right after the auto search operation is completed based on a table in which a specific program number is assigned to a peculiar channel of each country.

A current channel searching can be viewed during the auto search operation. That is, a percentage of channel search completion and a current frequency are displayed in real time through an On Screen Display (OSD) or Graphical User Interface (GUI). When a channel is searched, information about the searched channel and a program number assigned to the searched channel are displayed.

In a wireless TV that consists of a base station and one or more client TVs, because a tuner actually performing a channel tuning exists in the base station, the auto search function of searching a channel having an effective signal is performed in the base station. On the other hand, the client TV displays contents of a temporarily tuning channel while the auto search is in progress. During the auto search operation, the client TV updates in real time information including a searching frequency from 0 up to 888 MHz, an extent of total progress completion, a number of the searched channel, and a program number assigned to the searched channel, and displays the updated information through an OSD. Especially, in a case of a PAL TV, the information includes a station name.

The content of the tuning channel is transmitted from the base station to the client TV in the form of a compressed AV stream, and it is released from the compression by a dedicated decoder of the client TV and displayed in real time.

Information that has to be displayed through the OSD or GUI is transmitted from the base station to the client TV in the form of a command message, and the client TV performs a parsing with respect to the command message and performs a suitable OSD or GUI display.

During the auto search operation, since the OSD information to be displayed in real time is transmitted in every frequency from 0 to 888 MHz, a huge amount of command messages has to be transmitted from the base station to the client TV for a long time.

When analyzing and processing the command messages in a software level, the client TV requires much more time than when processing the compressed AV stream. As a result, there occurs inconsistence between the display of the contents of the tuning channel and the display of the OSD information. For example, a channel number 3 is being tuned after a channel number 2 was tuned, but the OSD information may indicate that the channel number 2 is being tuned.

Also, because much time (generally, about 5-6 minutes) is required for the auto search operation, even in the case of a general TV, a user feels boredom during the auto search operation. This problem becomes more serious in the wireless TV, because a huge amount of command messages has to be transceived between the base station for an actual channel search and the client TV for the display of information. Also, because of an overhead caused by the client TV processing the command messages, it takes much time (about 10 minutes) to perform the auto search operation.

Also, the command message transceived between the base station and the client TV may be lost due to a variety of factors of the wireless TV. Among information transmitted from the base station to the client TV during the auto search operation, information about the searched channel is very important. This information is stored in the base station or the client TV for later use after the auto search operation is completed. Mainly, this information is stored in the client TV because a user uses the client TV to input his/her commands. Therefore, when information about each searched channel is transmitted from the base station to the client TV, the client TV has to store the information about the searched channel in a non-volatile memory installed therein. However, when there occurs data loss due to a wireless characteristic, the client TV cannot store the information in the non-volatile memory and thus cannot display the channel information.

### SUMMARY OF THE INVENTION

The present invention has been developed in order to solve the above problems in the related art. Accordingly, an aspect of the present invention is to provide an auto search device capable of receiving and displaying channel data safely and effectively even in the case of a wireless TV system, and a method thereof.

The above aspect is achieved by providing an auto search device for a wireless transmitting and receiving apparatus. The device comprises: a receiver for receiving a control message with respect to information on a channel; a text message generator capable of displaying a message; a memory for storing information on a searched channel; and a controller, if the received control message is a data about a channel frequency, for driving the text message generator to display the text message, and if the received control message is a data about the searched channel, storing the data in the memory.

If the received data is about the searched channel, the controller updates the displayed text message and displays the updated text message.

The controller displays the data about the channel frequency every time when each channel is being tuned, and stores the data about the searched channel in the memory when tuning of each channel is complete. The controller further performs storing data about all of the searched channels in the memory when the channel search is complete.

The data about the channel frequency is smaller in size than the data about the searched channel. The data about the searched channel consists of a tuned frequency value of 2 bytes, a program number of 2 bytes, a broadcasting station name of tuned broadcasting of 5 bytes, and a sound system or a color system of tuned broadcasting of 1 byte.

The controller displays a frequency value which is now being tuned, a program number, a channel number, a percentage and a progress bar which indicate an extent of channel search completion. The controller displays the percentage and the progress bar which indicate the extent of channel search completion using data on the channel frequency.

The above aspect is also achieved by providing an auto search method of a wireless transmitting and receiving apparatus having an auto search function. The method comprises: receiving a control message; and displaying an extent of channel search completion in a text message or storing the same in a memory according to a result of reading out the control message.

The displaying operation comprises: displaying a text message if the received control message is a data about a channel frequency; and storing the data in a memory if the received control message is a data about the searched channel. The storing operation comprises updating the displayed text message and displaying the updated text message.

The text message displaying operation is performed every time when each channel is being tuned, and the storing operation is performed when each channel tuning is completed. The auto search method further comprises storing all of the searched channel data in the memory when the channel search is completed.

The data about the channel frequency is smaller than the data about the searched channel. The data about the searched channel consists of a tuned frequency value of 2 bytes, a program number of 2 bytes, a broadcasting station name of tuned broadcasting of 5 bytes, and a sound system or a color system of tuned broadcasting of 1 byte.

The text message displaying operation displays a frequency value which is now being tuned, a program number, a channel number, a percentage and a progress bar which indicate an extent of channel search completion. The percentage and the progress bar which indicate the extent of channel search completion are displayed using data on the channel frequency.

### BRIEF DESCRIPTION OF THE DRAWING FIGURES

The above aspect and other advantages of the present invention will be more apparent by describing an exemplary embodiment of the present invention with reference to the accompanying drawing figures, in which:

FIG. 1 is a block diagram showing a wireless receiver according to an exemplary embodiment of the present invention;

FIG. 2 is a flowchart showing a method of processing a command message of the wireless receiver; and

FIG. 3 is a view showing one example of a display when an auto search is in progress.

### DETAILED DESCRIPTION OF THE EXEMPLARY EMBODIMENTS

Hereinafter, the present invention will be described in greater detail with reference to the accompanying drawing figures.

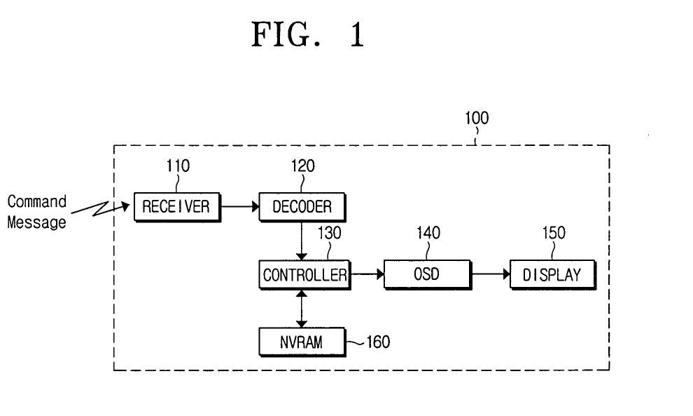

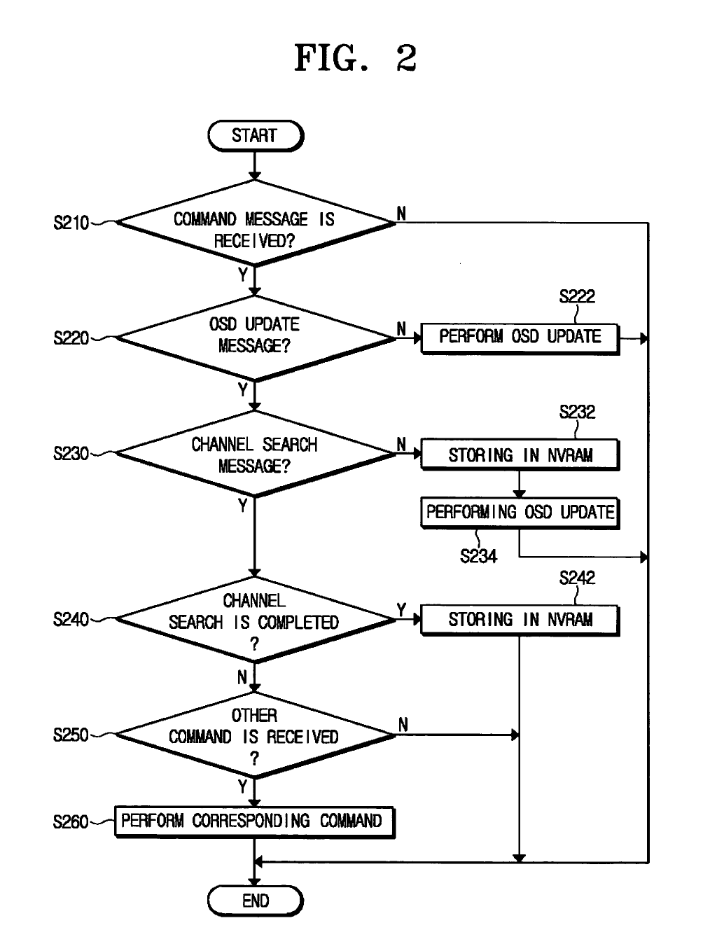

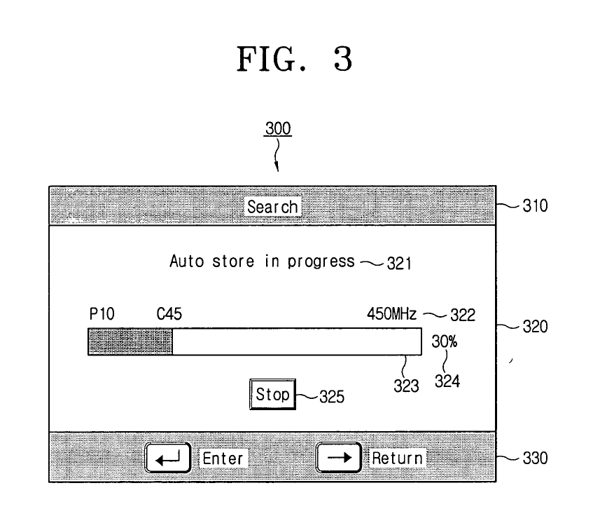

FIG. 1 is a block diagram showing main parts of a wireless receiver according to an exemplary embodiment of the present invention, FIG. 2 is a flowchart showing a method of processing a command message of a wireless receiver, and FIG. 3 is a view showing one example of display when an auto search is in progress.

Referring to FIGS. 1 to 3, a client TV 100 comprises a receiver 110, a decoder 120, a controller 130, an OSD 140, a display 150 and a non-volatile random access memory (NVRAM 160). The receiver 110 generally consists of a wireless module and receives an image signal from a transmitter such as a base station (not shown), reads out data of a predetermined unit (e.g. 8 Mbps) from the image signal and sends it to the decoder 120. Also, the receiver 110 transmits a command message received from the transmitter to the decoder 120.

The decoder 120 decodes the image signal transmitted from the wireless receiver 110 and simultaneously transmits the received command message to the controller 130 according to a specific protocol.

The controller 130 processes the image signal transmitted from the base station to display it on the display 150 and simultaneously reads out the received command message to display a corresponding message on the display 150 or store corresponding information in the NVRAM 160 by driving the OSD 140. The controller 130 controls the OSD 140 to update and display position information, channel information and a percentage of channel searching completion based on frequency information included in the command message. An OSD window 300 has an upper section 310 for displaying current states of the base station and the client TV, a display section 320 for displaying a channel searching, and a lower section 330 for showing relevant keys. The display section 320 has an “auto search in progress” display part 321 in a first line to display a detail operation of the receiver 110, and a channel display part 322 in a second line to display a position number P10, a current channel number C45 and a frequency (450 MHz) of the channel. A progress bar 323 and a percentage 324 indicating a channel search completion are displayed in the third line. The last line displays the legend “STOP” 325 to instantly stop the channel search. The legend “STOP” 325 allows a user to forcedly stop the channel search.

The NVRAM 160, which is as a non-volatile memory, stores information on the channel searched under the control of the controller 130. Especially, the NVRAM 160 stores sound information, color information, a station name, a program number and a channel number of a tuning-completed channel. The station name of a Europe-oriented model is expressed in specific characters. The sound information may be expressed by BG, DK, I, M, L, and the color information may be expressed by NTSC, PAL, SECAM, Auto.

An auto search method according to an exemplary embodiment of the present invention will be described with reference to FIG. 2.

Information received during an auto search operation is divided into two types of information in this embodiment. One is a to-be-updated OSD information message (referred to as an “OSD Update Message”, herein below) such as a current frequency and a percentage of channel search completion, which have to be continuously updated regardless of whether the channel has been searched. The other is a searched channel information message (referred to as a “Channel Search Message”, herein below) such as a channel number and an assigned program number, which have to be updated additionally at the time when a specific channel is searched. The “Channel Search Message” includes a station name expressed by characters in a case of a Europe-oriented TV. The “Channel Search Message” is approximately 10 Bytes long, and the “OSD Update Message” is approximately 2 Bytes long, which is relatively shorter than the “Channel Search Message”. Therefore, in order to transmit the data safely and rapidly, the data is divided. Also, a progress bar 323 and a percentage 324 can be expressed by frequency information. That is, when a frequency band ranging from 0 to 888 MHz is scanned, a progress bar can be expressed by comparing a received frequency with a frequency band ranging from 0 to 888 MHz and also the percentage can be seen through the progress bar. In the OSD window 300 as shown in FIG. 3, the “OSD Update Message” is about the progress bar 323 and the percentage 324 of channel search completion, and the “Channel Search Message” is about the channel number, the assigned program number, and the station name which is expressed in characters in a case of Europe-oriented TV.

Also, the “Channel Search Message” has to be stored in a non-volatile memory. Also, information on a system and a color system the client TV manages in addition to the “OSD Update Message” is also transmitted.

When the receiver 110 receives a command message from the base station at operation S210, the controller 130 determines whether the received command message is an “OSD Update Message” at operation S220. The command message is generally transmitted from the base station to the client TV 100 when an auto search is in progress. If the received command message is determined to be the “OSD Update Message” at operation S220, the controller 130 drives the OSD 140 to display the OSD window as shown in FIG. 3 on the display 150, so that a viewer can observe a current status of channel search progress at operation S222. The command message received at operation S210 is divided into the “OSD Update Message” and the “Channel Search Message” according to an OP code (operation code). The “OSD Update Message” is constituted generally by frequency data of 2 Bytes. This is because the relatively short command message makes it possible for the client TV 100 to process the data rapidly. The controller 130 obtains a percentage of channel search completion based on the frequency data of 2 Bytes, displays a transmitted frequency value and the obtained percentage on the channel information part 322 and the percentage part 323, respectively. The progress bar 323 corresponding to the percentage is displayed to indicate the extent of channel search completion.

If the command message received at operation S220 is not determined to be the “OSD Update Message”, it is determined whether it is the “Channel Search Message” (operation of S230). If the command message is not the “Channel Search Message”, the transmitted data is stored in the NVRAM 160 (operation of S232) and the OSD 140 is controlled to update information displayed in the OSD window 300 at operation S234. The “Channel Search Message” may consist of 10 Bytes, each Byte being allocated such that 2 Bytes are used to indicate a value of a tuned frequency value, 2 Bytes to indicate a program number, 5 Bytes to indicate a station name of a tuned broadcast, and 1 Byte to indicate a sound system or a color system of the tuned broadcast. Since the “Channel Search Message” indicates a result of searching a certain channel, the program number P10 and the channel number C45 of the channel information part 322 are updated and displayed through the OSD.

If the command message is not determined to be the “Channel Search Message” at operation S230, the controller 130 determines whether the received command message a message received after the channel search is completed at operation S240. This operation is to recover data that is lost during the channel search operation (Hereinafter, this operation is referred to as an Auto Sort). In order to avoid a possible disadvantage caused by the stop of the channel search at operations S230 to S232, the information on the searched channel has to be stored in the NVRAM 160. Accordingly, when the channel search is suddenly stopped, it is possible to tune the once-searched channel based on the searched channel information stored in the NVRAM 160. In this case, however, there is no way to recover the lost channel information. When the auto search is completed even if there occurs the channel information loss in the middle of performing the auto search operation, the PAL returns the auto-sorted channel information back to the client TV and stores it. Accordingly, even if there occurs a data loss in searching channels, the lost data can be recovered through this procedure.

The NTSC TV which has no auto sort function performs a verification phase to load the total searched channel information continuously after the auto search is completed. This is to respond to the channel information loss.

If the transmitted command message is determined to be a general command unrelated to the channel information at operation S250, a corresponding command is executed and then procedure is completed at operation S260. If the command message is not received at operation S210 and is not the general command or is an error command at operation S250, a procedure is finished.

As described above, the message obtained in searching channels is divided into the “Channel Search Message” and “OSD Update Message” to display the message effectively according to a situation. Accordingly, when a specific channel is being searched, the client TV processes the relatively shorter “OSD Update Message”, whereas at the moment when the channel has been searched, the client TV processes the relatively longer “Channel Search Message”.

Although in this embodiment a text message is displayed by using the OSD 140, a corresponding screen may be configured by the GUI (Graphic User Interface) and stored in the NVRAM 160 or an extra memory. Accordingly, the controller 130 controls such that the GUI is displayed without using the OSD 140.

According to the auto search device and the method thereof, since the message received at the receiver is divided into the relatively shorter “OSD Update Message” and the relatively longer “Channel Search Message”, the problem of inconsistence between the image display of tuning channel and the display of the OSD information in the related art can be solved, and the client TV can process the control message from the base station rapidly and effectively and thus the time required for the auto channel operation can be reduced.

Also, according to the present invention, the data loss, which may occur due to the wireless characteristic, can be compensated by the auto sort procedure of re-transmitting the total channel information continuously.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An auto search device for a wireless transmitting and receiving apparatus, the device comprising:
a receiver which receives a control message with respect to information on a channel;
a text message generator capable of displaying a message;
a memory which stores information on a searched channel; and
a controller which controls display of an extent of channel search completion in a text message by driving the text message generator and stores the extent of channel search completion in the memory, according to a result of reading the control message from the receiver.

2. The auto search device as claimed in claim 1, wherein the controller, if the received control message is a data about a channel frequency, drives the text message generator to display the text message, and if the received control message is a data about the searched channel, stores the data about the searched channel in the memory.

3. The auto search device as claimed in claim 1, wherein the controller, if the received data is about the searched channel, updates the displayed text message and displays the updated text message.

4. The auto search device as claimed in claim 2, wherein the controller displays the data about the channel frequency every time when each channel is being tuned, and stores the data about the searched channel in the memory when tuning of each channel is complete.

5. The auto search device as claimed in claim 2, wherein the controller controls storing data about all of the searched channels in the memory when the channel search is complete.

6. The auto search device as claimed in claim 2, wherein the data about the channel frequency is smaller in size than the data about the searched channel.

7. The auto search device as claimed in claim 6, wherein the data about the searched channel comprises a tuned frequency value of 2 bytes, a program number of 2 bytes, a broadcasting station name of tuned broadcasting of 5 bytes, and a sound system or a color system of tuned broadcasting of 1 byte.

8. The auto search device as claimed in claim 1, wherein the controller displays a frequency value which is now being tuned, a program number, a channel number, a percentage and a progress bar which indicate an extent of channel search completion.

9. The auto search device as claimed in claim 8, wherein the controller displays the percentage and the progress bar which indicate the extent of channel search completion using data on the channel frequency.

10. An auto search method of a wireless transmitting and receiving apparatus having an auto search function, the method comprising:
receiving a control message; and
displaying an extent of channel search completion in a text message or storing the extent of channel search completion in the text message in a memory according to a result of reading out the control message.

11. The auto search method as claimed in claim 10, wherein the displaying operation comprises:
displaying the text message if the received control message is a data about a channel frequency; and
if the received control message is a data about the searched channel, storing the data about the searched channel in a memory.

12. The auto search method as claimed in claim 11, wherein the storing operation comprises updating the displayed text message and displaying the updated text message.

13. The auto search method as claimed in claim 11, wherein the text message displaying operation is performed every time when each channel is being tuned, and the storing operation is performed when each channel tuning is completed.

14. The auto search method as claimed in claim 10, further comprising storing all of the searched channel data in the memory when the channel search is completed.

15. The auto search method as claimed in claim 11, wherein the data about the channel frequency is smaller than the data about the searched channel.

16. The auto search method as claimed in claim 15, wherein the data about the searched channel consists of a tuned frequency value of 2 bytes, a program number of 2 bytes, a broadcasting station name of tuned broadcasting of 5 bytes, and a sound system or a color system of tuned broadcasting of 1 byte.

17. The auto search method as claimed in claim 16, wherein the text message displaying operation displays a frequency value which is now being tuned, a program number, a channel number, a percentage and a progress bar which indicate an extent of channel search completion.

18. The auto search method as claimed in claim 17, wherein the percentage and the progress bar which indicate the extent of channel search completion are displayed using data on the channel frequency.
